(19) United States
(12) Patent Application Publication
(10) Pub. No.: US 2026/0046528 A1
(43) Pub. Date: Feb. 12, 2026

(54) IMAGE PICKUP APPARATUS CAPABLE OF CORRECTING FLICKER OCCURRING IN IMAGE, CONTROL METHOD FOR IMAGE PICKUP APPARATUS, AND STORAGE MEDIUM

(71) Applicant: CANON KABUSHIKI KAISHA, Tokyo (JP)

(72) Inventor: TAIKI AKAMA, Kanagawa (JP)

(21) Appl. No.: 19/256,721

(22) Filed: Jul. 1, 2025

(30) Foreign Application Priority Data
Aug. 7, 2024 (JP) 2024-130810

(51) Int. Cl. H04N 23/745; H04N 23/73

(52) U.S. Cl. CPC H04N 23/745; H04N 23/73

(57) ABSTRACT

An image pickup apparatus capable of correcting flicker occurring in an image photographed with an arbitrary exposure time even in moving body photographing is provided. The image pickup apparatus that reads out an image by using an image pickup device having a plurality of pixels includes at least one processor and/or circuit configured to function as a detecting unit that detects a flicker frequency from the image read out from the image pickup device, an image readout unit that reads out a first image exposed with an arbitrary exposure time from the image pickup device, a readout unit that simultaneously performs readout of a plurality of images from the image pickup device, a detecting unit that detects a flicker area in the first image where flicker is occurring by using the flicker frequency and the plurality of images, and a correcting unit that corrects the flicker in the flicker area.

### BACKGROUND

### Field of the Technology

The present disclosure relates to an image pickup apparatus, a control method for the image pickup apparatus, and a storage medium, and more particularly to an image pickup apparatus that corrects flicker, a control method for the image pickup apparatus, and a storage medium.

### Description of the Related Art

When photographing is performed with respect to a light source that blinks rapidly, such as a light emitting diode light source (an LED light source), with an exposure time faster than the blinking, uneven blinking (hereafter, referred to as “flicker”) will occur in the photographed image. It has been known that the occurrence of the flicker is capable of being suppressed by performing photographing with an exposure time that is an integer multiple of a flicker frequency. However, this method does not allow a user to perform photographing with an arbitrary exposure time, and subject blurring will occur, for example, in a scene where a subject moves vigorously. For this reason, methods for correcting flicker that occurs in an image photographed with an arbitrary exposure time have been proposed.

For example, in a conventional technique disclosed in Japanese Laid-Open Patent Publication (kokai) No. 2012-119788, when photographing subjects including a flickering light source, first, a flicker area is detected from the photographed image. Next, when a 1st image is photographed with an arbitrary exposure time, if flicker occurs in the 1st image, photographing of a 2nd image, in which the occurrence of flicker is suppressed, is performed. Then, the flicker area of the 2nd image is composited with the 1st image to correct the flicker.

However, in the conventional technique disclosed in Japanese Laid-Open Patent Publication (kokai) No. 2012-119788, since the flicker area is detected by comparing images photographed in succession, in a scene where the subject moves vigorously, it is difficult to distinguish whether a difference is due to the movement of the subject or flickering light source. Therefore, in moving body photographing (moving subject photographing), it is difficult to generate an image in which flicker has been corrected.

### SUMMARY

The present disclosure provides an image pickup apparatus capable of correcting flicker occurring in an image photographed with an arbitrary exposure time even in moving body photographing, a control method for the image pickup apparatus, and a storage medium.

Accordingly, an aspect of the present disclosure provides an image pickup apparatus that reads out an image by using an image pickup device having a plurality of pixels, the image pickup apparatus comprising at least one processor and/or circuit configured to function as a frequency detecting unit that detects a flicker frequency from the image that has been read out from the image pickup device, an image readout unit that reads out a first image that has been exposed with an arbitrary exposure time from the image pickup device, an image simultaneous readout unit that simultaneously performs readout of a plurality of images from the image pickup device, a flicker area detecting unit that detects a flicker area in the first image where flicker is occurring by using the flicker frequency that has been detected by the frequency detecting unit and the plurality of images that have been read out by the image simultaneous readout unit, and a correcting unit that corrects the flicker in the flicker area.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that illustrates a hardware configuration of an image pickup apparatus according to an embodiment of the present disclosure.

FIG. 2 is a diagram for explaining a method of simultaneously reading out a plurality of images by an image pickup device included in the image pickup apparatus illustrated in FIG. 1.

FIG. 3 is a diagram for explaining changes in flicker caused by differences in an exposure time and a readout start timing.

FIG. 4 is a flowchart of a photographing control processing according to the embodiment of the present disclosure.

FIG. 5 is a timing chart of simultaneous readout image photographing executed in a step S403 of FIG. 4.

FIG. 6 is a diagram for explaining a flicker area detection processing executed in a step S404 of FIG. 4.

### DESCRIPTION OF THE EMBODIMENTS

The present disclosure will now be described in detail below with reference to the accompanying drawings showing embodiments thereof.

Hereinafter, a preferred embodiment of the present disclosure will be described in detail with reference to the accompanying drawings.

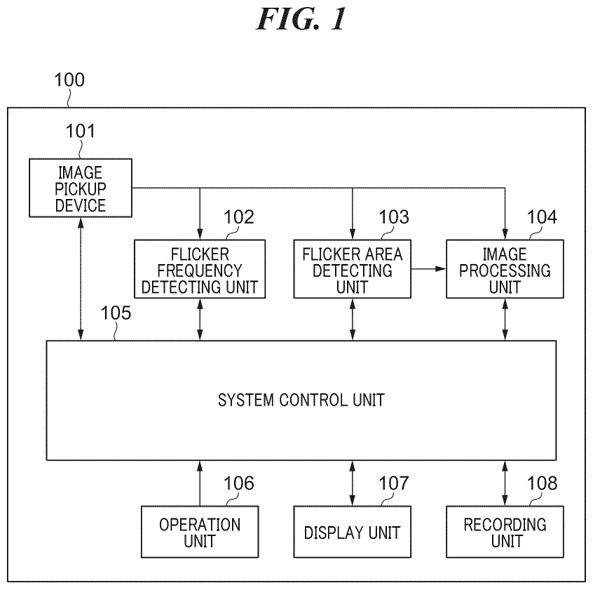

FIG. 1 is a block diagram that illustrates a hardware configuration of an image pickup apparatus 100 according to the embodiment of the present disclosure.

As shown in FIG. 1, the image pickup apparatus 100 includes an image pickup device 101, a flicker frequency detecting unit 102, a flicker area detecting unit 103, an image processing unit 104, a system control unit 105, an operation unit 106, a display unit 107, and a recording unit 108.

The image pickup apparatus 100 is, for example, a lens-interchangeable digital camera, to which any lens is capable of being attached, and has a still image photographing function and a moving image pickup function. In addition, the image pickup apparatus 100 is capable of photographing still images successively at high speed, and for example, is capable of photographing 40 still images per second. However, the photographing speed of 40 images per second is merely an example of the present embodiment, and the present disclosure is not limited to this photographing speed.

The image pickup device 101 performs photoelectric conversion with respect to an optical image of a subject at each pixel to generate charges in accordance with the amount of incident light, converts the charges into electrical signals, converts the electrical signals into digital image data, and outputs the digital image data. In addition, the image pickup device 101 has an electronic shutter function that adjusts the amount of the incident light on each pixel, and is capable of controlling an exposure time of image signals. In addition, the image pickup device 101 is capable of simultaneously performing readout of a plurality of images, at different readout times. Details thereof will be described below.

The flicker frequency detecting unit 102 (a frequency detecting unit) calculates a frequency of flicker (a flicker frequency) based on the image signals obtained from the image pickup device 101.

The flicker area detecting unit 103 (a flicker area detecting unit) detects a flicker area on an image surface by using a plurality of images obtained and simultaneously read out from the image pickup device 101.

The image processing unit 104 (a correcting unit) uses the images obtained from the image pickup device 101 and the flicker area detected by the flicker area detecting unit 103 to generate an image in which the influence of the flicker has been reduced (in which the flicker has been corrected). At this time, the image processing unit 104 generates the image by using a trained model that has been trained to correct the flicker area based on a plurality of images photographed at different shutter speeds and the detected flicker area. Here, the plurality of images photographed at different shutter speeds include at least an image photographed at a shutter speed that reduces the flicker and an image photographed at an arbitrary shutter speed. However, the above-described image processing method executed by the image processing unit 104 is merely an example of the present embodiment, and the present disclosure is not limited to this image processing method.

The system control unit 105 includes a central processing unit (a CPU), a read only memory (a ROM), and a random access memory (a RAM), all of which are not shown in FIG. 1, that are built therein, and the CPU loads a program stored in the ROM into the RAM and executes it, thereby controlling the entire image pickup apparatus 100.

The operation unit 106 includes operation members such as various kinds of switches, various kinds of buttons, and a touch panel that accept various kinds of operations from a user, a line-of-sight detection device, a voice recognition device, or a combination of these.

The system control unit 105 controls various kinds of operations of the image pickup apparatus 100 in response to signals based on operations on the operation unit 106.

The display unit 107 is a display device such as a liquid crystal display (an LCD) or an organic electroluminescence display (an organic EL display) that displays image data, menus, and the like. The display unit 107 has an electronic viewfinder function (an EVF function) that is turned on or off under the control of the system control unit 105. In addition, the display unit 107 displays a menu screen or the like that allows the user to operate and input various kinds of settings, various kinds of processes, and the like for the image pickup apparatus 100.

The recording unit 108 records the image data outputted from the image pickup device 101, the flicker area detected by the flicker area detecting unit 103, the image generated by the image processing unit 104, and the like.

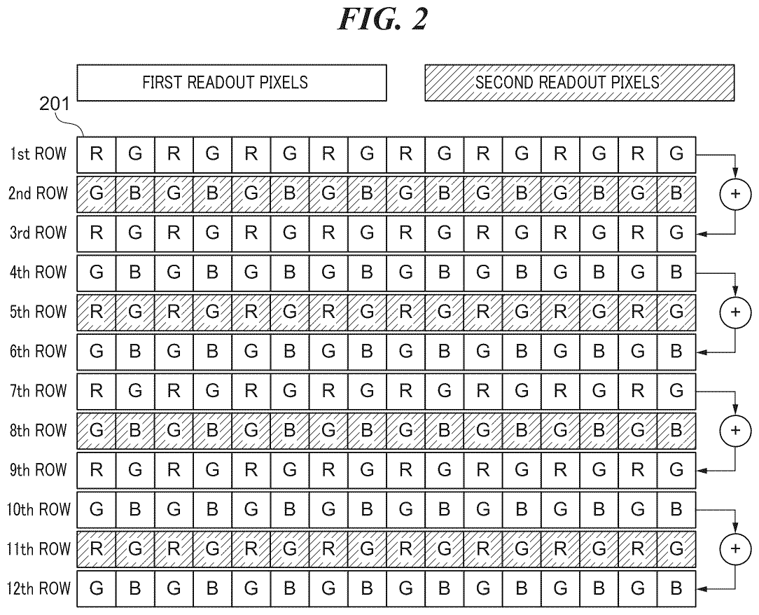

Next, a method for simultaneously reading out a plurality of images by the image pickup device 101 will be described with reference to FIG. 2. Here, in the present embodiment, the image pickup device 101 simultaneously reads out two types of images, at different readout times.

As shown in FIG. 2, the image pickup device 101 includes a pixel array 201 on its image surface, the pixel array 201 being configured by arranging a plurality of pixels in a two-dimensional array.

Three types of color filters, a red (R) color filter, a green (G) color filter, and a blue (B) color filter, are arranged in a Bayer array on each pixel of the pixel array 201. Specifically, two types of pixel rows, R rows (i.e., odd-numbered rows shown in FIG. 2) including pixels on which red color filters are arranged and B rows (i.e., even-numbered rows shown in FIG. 2) including pixels on which blue color filters are arranged, are arranged alternately.

The simultaneous readout of two images is performed from different pixel rows in the same photographing cycle (a three-row cycle in the present embodiment). In each photographing cycle (in each three-row cycle), a first readout is performed by adding up two pixel rows with the same color filters, and a second readout is performed by using a pixel row that is not used in the first readout. As a result, it becomes possible to simultaneously read out two types of images.

In the present embodiment, since the number of pixels used in the second readout is smaller than the number of pixels used in the first readout, a readout time of the second readout becomes a time shorter than a readout time of the first readout. As described above, the readout of the plurality of images is simultaneously performed at different readout times.

In addition, in the present embodiment, the first readout has been performed by adding up the two pixel rows with the same color filters in the three-row cycle, but addition rates of the pixels may be changed, or the pixels may not be added up. In addition, the method is not limited to the method of the present embodiment as long as the readout time is capable of being controlled to be different between the first readout and the second readout. For example, the readout time of the first readout and the readout time of the second readout may be controlled by changing the number of the pixels used in the first readout and the number of the pixels used in the second readout.

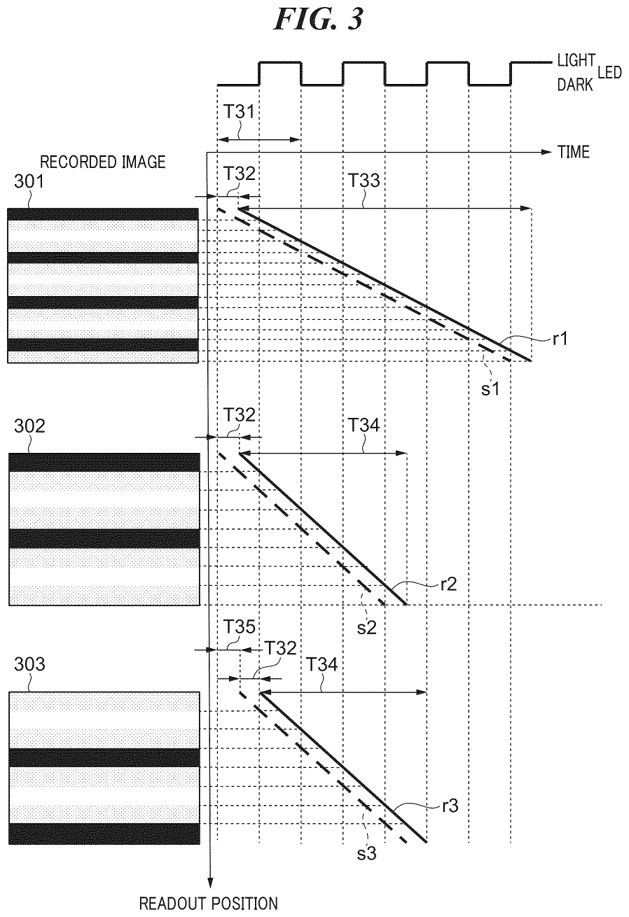

Next, changes in the flicker caused by differences in the exposure time and a readout start timing will be described with reference to FIG. 3. Here, in the present embodiment, a case will be described in which photographing is performed by using a rolling shutter method in which resetting and reading out each pixel of the pixel array 201 are sequentially performed row by row under an LED light source that blinks with a blinking period T31. As shown in FIG. 3, a graph represents a time on the horizontal axis and a readout position of the pixel on the vertical axis, with s1 to s3 respectively representing a reset timing of each pixel of the pixel array 201, and r1 to r3 respectively representing a readout timing of each pixel of the pixel array 201.

A recorded image 301 represents an image that has been affected by flicker on the image surface caused by the LED light source when photographing has been performed by using the first readout with an exposure time T32 and a readout time T33. In addition, a start timing of the photographing is made to coincide with the blinking period T31 of the flicker.

A recorded image 302 represents an image that has been affected by the flicker on the image surface caused by the LED light source when photographing has been performed by using the second readout with the same start timing as the recorded image 301, the same exposure time T32, and a readout time T34 (<T33) shorter than the readout time of the recorded image 301. Since the readout time of the recorded image 302 (the readout time T34) is shorter than the readout time of the recorded image 301 (the readout time T33), the number of stripes of the flicker on the recorded image 302 is reduced (the recorded image 302 has fewer stripes of the flicker). In other words, as shown in the recorded image 301 and the recorded image 302, in the case where photographing has been performed at different readout times, the manner, in which the stripes of the flicker occur, will change.

In addition, a recorded image 303 represents an image that has been affected by the flicker on the image surface caused by the LED light source when photographing has been performed under the same conditions as the recorded image 302, except that the start timing of the photographing is delayed by a difference time T35. In this way, when the start timing of the photographing is shifted from the blinking period T31 of the flicker by the difference time T35, the manner, in which the stripes of the flicker occur, changes as in the recorded image 303 compared to the recorded image 302. In other words, as shown in the recorded image 302 and the recorded image 303, when the blinking period of the flicker differs from the start timing of the photographing, the manner, in which the stripes of the flicker occur, will change.

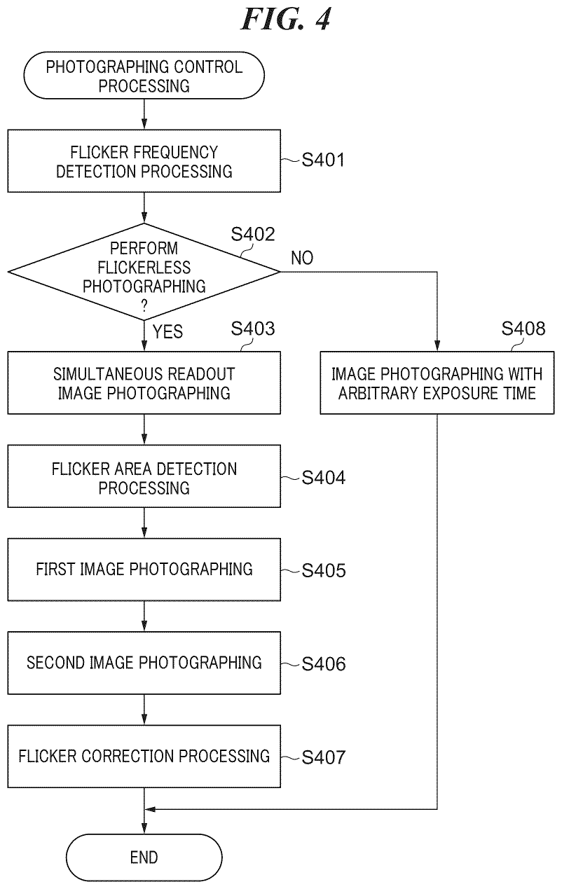

Next, a photographing control processing according to the present embodiment will be described with reference to a flowchart of FIG. 4. Specifically, the photographing control processing is executed by the CPU built into the system control unit 105 loading a program stored in the ROM into the RAM, but hereinafter, the main entity executing the photographing control processing will simply be the system control unit 105.

As shown in FIG. 4, in a step S401, the system control unit 105 controls the flicker frequency detecting unit 102 to execute a flicker frequency detection processing that detects a flicker frequency from an image that has been read out from the image pickup device 101. In the present embodiment, a method that has been known as a flicker frequency detection method is used in which an image is divided into a plurality of regions, and differences in the amount of light in images obtained by successive image pickup are detected and compared. However, the flicker frequency detection method is not limited to this method, and may be replaced with another detection method depending on the purpose.

In a step S402, the system control unit 105 determines whether or not flickerless photographing for performing flicker correction is necessary, based on the flicker frequency that has been detected in the step S401. In the present embodiment, in the case where the flicker frequency that has been detected in the step S401 is within a certain fixed range, the system control unit 105 determines that the flickerless photographing is necessary (YES in the step S402), and the photographing control processing proceeds to a step S403. On the other hand, in the case where the flicker frequency that has been detected in the step S401 is not within the certain fixed range, the system control unit 105 determines that the flickerless photographing is not necessary (NO in the step S402), and the photographing control processing proceeds to a step S408. It should be noted that the method for determining whether or not the flickerless photographing is necessary is not limited to the above-described determination method used in the present embodiment. Depending on the purpose, the method for determining whether or not the flickerless photographing is necessary may be replaced with another method, for example, a method in which when the user selects whether or not to perform flicker area detection by using the operation unit 106, depending on the result of the selection, determining whether or not the flickerless photographing is necessary is performed.

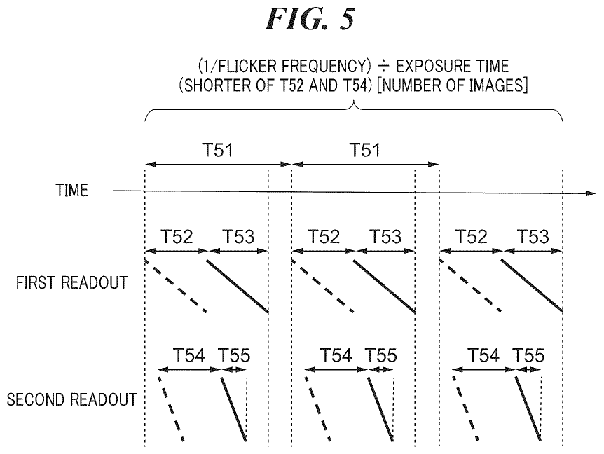

In the step S403, the system control unit 105 (an image simultaneous readout unit) controls the image pickup device 101 to perform simultaneous readout image photographing. In the present embodiment, two types of images are simultaneously photographed multiple times by the simultaneous readout image photographing. The simultaneous readout image photographing will be described in detail below with reference to FIG. 5.

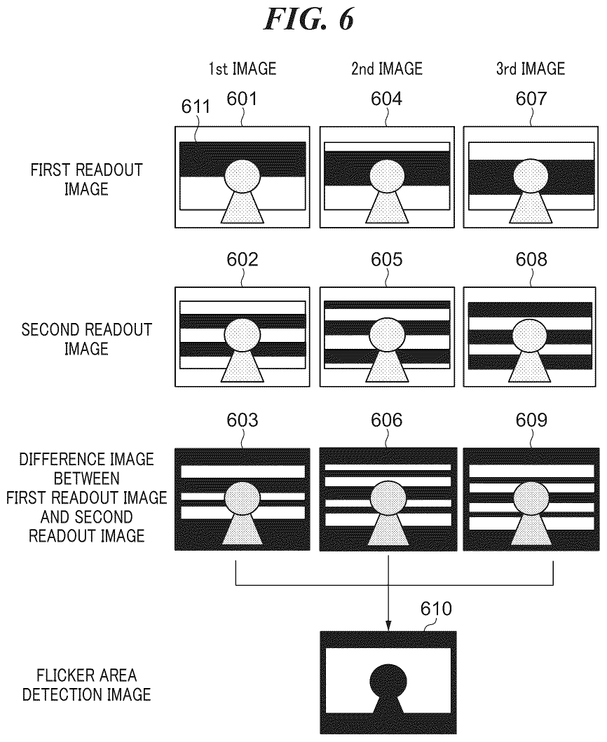

In a step S404, the system control unit 105 controls the flicker area detecting unit 103 to execute a flicker area detection processing by using the two types of images that have been photographed in the step S403. The flicker area detection processing will be described in detail below with reference to FIG. 6.

In a step S405, the system control unit 105 (an image readout unit) controls the image pickup device 101 to photograph a first image with an arbitrary exposure time. The arbitrary exposure time is, for example, an exposure time in accordance with photographing conditions set by the user using the operation unit 106.

In a step S406, the system control unit 105 controls the image pickup device 101 to photograph a second image with an exposure time that suppresses the occurrence of flicker. The exposure time that suppresses the occurrence of flicker is, for example, an integer multiple of the flicker frequency that has been detected in the step S401. At this time, in order to suppress the influence of a moving body, the step S405 and the step S406 are carried out at a photographing speed of 40 images per second, that is, at an interval of 0.025 ms. It should be noted that the photographing interval between the first image and the second image is not limited to the interval of 0.025 ms, and is preferably as short as possible in order to suppress the influence of a moving body (that is, in order to suppress the influence of a moving body, it is preferable to carry out the step S405 and the step S406 at an interval as short as possible). In addition, in the present embodiment, the second image is photographed after an exposure timing of the first image, but the present disclosure is not limited to this as long as the first image and the second image are photographed successively at high speed. For example, the second image may be photographed before the exposure timing of the first image, or both before and after the exposure timing of the first image. However, it is preferable to photograph one second image before the exposure timing of the first image and one second image after the exposure timing of the first image, rather than photographing one second image before the exposure timing of the first image or after the exposure timing of the first image. As a result, since the accuracy of determining whether the change between the three images, the first image and the two second images, is due to the influence of the subject that is a moving body or the influence of flicker is improved, it is possible to improve the processing accuracy of the next step S407.

In the step S407, the system control unit 105 controls the image processing unit 104 to perform a flicker correction processing on the first image that has been obtained in the step S405. Specifically, in the present embodiment, the flicker correction processing is a processing in which the image processing unit 104 replaces an area in the first image that has been obtained in the step S405 where flicker occurs with the second image that has been obtained in the step S406. At this time, the image processing unit 104 uses a trained model that has been trained based on training data to receive the detected flicker area, the first image, and the second image as input, and output an image in which the area where flicker occurs of an area of the first image is complemented with the second image. It should be noted that the means (method) of the flicker correction processing is not limited to this, and the means (method) of the flicker correction processing may be switched depending on the purpose. For example, the difference in gain of the flicker area that has been detected in the step S404 may be calculated from the first image that has been obtained in the step S405 and the second image that has been obtained in the step S406, and the flicker that has occurred in the first image may be corrected in accordance with the calculation result. The system control unit 105 records the first image that has been subjected to the flicker correction processing in the step S407 in the recording unit 108, and then ends the photographing control processing.

In the step S408, in the case of being determined in the step S402 that the flickerless photographing is not to be performed, the system control unit 105 controls the image pickup device 101 to photograph an image with an arbitrary exposure time as in the step S405, records the photographed image in the recording unit 108, and then ends the photographing control processing.

Next, a method for the simultaneous readout image photographing executed in the step S403 will be described with reference to a timing chart of FIG. 5.

In the step S403, the system control unit 105 controls the image pickup device 101 to have a photographing cycle T51, an exposure time T52 of the first readout, a readout time T53 of the first readout, an exposure time T54 of the second readout, and a readout time T55 of the second readout.

In the present embodiment, the system control unit 105 controls the exposure time T52 of the first readout and the exposure time T54 of the second readout to be the same time, and controls the readout time T53 of the first readout and the readout time T55 of the second readout to be different times, thereby performing three simultaneous readouts (that is, performing the simultaneous readout three times). In this way, by making the exposure time T52 of the first readout equal to the exposure time T54 of the second readout (T52=T54), a difference between an image of the first readout (a first readout image) and an image of the second readout (a second readout image) becomes small, and similarly, it is possible to reduce erroneous detections other than flicker.

However, if two or more types of images are capable of being read out simultaneously in the same photographing cycle to obtain images with different exposure times for the same scene, and a difference in an area other than flicker (such as a difference in a moving body) is capable of being reduced, control different from that of the present embodiment may be performed.

For example, the control may be performed so that the exposure time T52 of the first readout and the exposure time T54 of the second readout become different times, rather than becoming the same time as in the present embodiment. Since a difference in the exposure time due to this control results in a difference in the appearance of stripes of the flicker, it is possible to detect the flicker as a difference. However, it should be noted that since the difference in the area other than the flicker will also become large, this may lead to erroneous detection.

In addition, the control may be performed so that the readout time T53 of the first readout and the readout time T55 of the second readout become the same time, rather than becoming different values (different times) as in the present embodiment.

The system control unit 105 controls the image pickup device 101 so that a cycle of the second readout (=T54+T55) overlaps with a cycle of the first readout (=T52+T53), thereby performing photographing. As a result, since the difference in the area other than the flicker (such as the difference in the moving body) is capable of being reduced, it is possible to reduce the erroneous detections other than the flicker.

Simultaneous readout of the first readout and the second readout is repeated a number of times equal to or greater than a value obtained by dividing a reciprocal of the flicker frequency that has been detected in the step S401 (hereinafter, referred to as “a flicker period”) by the shorter time of the exposure time T52 of the first readout and the exposure time T54 of the second readout (<the flicker period). As a result, it is possible to ensure a total exposure time of the images used for flicker detection to be equal to or longer than the flicker period. It should be noted that in the case where the exposure time T52 of the first readout is made to equal to the exposure time T54 of the second readout (T52=T54) as in the present embodiment, the same effect is capable of being obtained by making T52 shorter than the flicker period and repeating the simultaneous readout of the first readout and the second readout a number of times equal to or greater than a value obtained by dividing the flicker period by T52.

At this time, the system control unit 105 performs control so that the photographing cycle T51 of multiple simultaneous readouts (the simultaneous readout multiple times) becomes a period different from the flicker period, and performs photographing. This is because if the photographing cycle T51 is made the same as the flicker period, the stripes of the flicker will become fixed (a phenomenon will occur in which a specific stripe state is maintained in the photographed image), and in the difference image, there is an area that is undetectable as the flicker. For this reason, in the present embodiment, the photographing cycle T51 is made to be a period different from the flicker frequency, thereby improving the accuracy of detecting flicker.

It should be noted that as shown in the example of FIG. 5, it is preferable to perform photographing by making the readout times of the first readout image and the second readout image different (T53≠T55), for example, by controlling the readout times of the first readout image and the second readout image so that T53<the flicker period <T55. As a result, since there is a time difference in reading out each line, when the difference between the first readout image and the second readout image is taken, the stripes of the flicker appear differently, and it is possible to detect the flicker as the difference.

In addition, the control method for this simultaneous readout may be switched depending on the detected flicker frequency or a blinking method.

In addition, the control method may be switched depending on the exposure time or the readout time, for example by performing multiple cycles of the second readout during the cycle of the first readout (=T52+T53).

Next, the flicker area detection processing executed in the step S404 will be described with reference to FIG. 6. In the present embodiment, the simultaneous readout of two types of images is executed three times, and the flicker area detection processing is executed by using these images.

The two types of images obtained by the simultaneous readout include an image obtained by the first readout (hereinafter, referred to as the first readout image) and an image obtained by the second readout (hereinafter, referred to as the second readout image). As described above, the first readout image and the second readout image are images with different readout times, and therefore the manner, in which the stripes of the flicker occur, differs between the first readout image and the second readout image. In addition, since the first readout image and the second readout image are photographed at a timing where the exposure times overlap, the first readout image and the second readout image are images in which there is little difference in areas other than a flicker area 611. Therefore, as in a 1st simultaneous readout shown in FIG. 6, when a difference between a first readout image 601 and a second readout image 602 is taken, as shown in a difference image 603, it is possible to extract almost the entire flicker area 611.

However, there is a slight difference between the start timings of photographing the first readout image 601 and the second readout image 602 and the flicker period, and there is an area in the difference image 603 where flicker is occurring but is not detected as the flicker area 611. Therefore, in the present embodiment, a 2nd simultaneous readout and a 3rd simultaneous readout are also performed at start timings different from the start timing of the 1st simultaneous readout.

The 1st first readout image 601 and a 2nd first readout image 604 are photographed at different start timings, and therefore, as described above with reference to FIG. 3, stripes of the flicker appear in different ways. Therefore, in a 2nd difference image 606 obtained by taking a difference between the 2nd first readout image 604 and a 2nd second readout image 605, an area different from that in the 1st difference image 603 is extracted as a difference.

Similarly, in a 3rd difference image 609 obtained by extracting a difference between a 3rd first readout image 607 and a 3rd second readout image 608, an area different from that in the 1st difference image 603 and that in the 2nd difference image 606 is extracted as a difference.

Therefore, by adding the 1st difference image 603, the 2nd difference image 606, and the 3rd difference image 609, it is possible to obtain a flicker area detection result 610. At this time, as shown in the flicker area detection result 610, by performing photographing in the step S403 the number of images obtained by dividing the flicker period by the exposure time or more, it is possible to prevent the flicker area from being overlooked in detection.

According to the present disclosure, it is possible to correct the flicker occurring in the image photographed with the arbitrary exposure time even in the moving body photographing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-130810, filed Aug. 7, 2024, which is hereby incorporated by reference herein in its entirety.

What is claimed is:

1. An image pickup apparatus that reads out an image by using an image pickup device having a plurality of pixels, the image pickup apparatus comprising:
at least one processor and/or circuit configured to function as:
a frequency detecting unit that detects a flicker frequency from the image that has been read out from the image pickup device;
an image readout unit that reads out a first image that has been exposed with an arbitrary exposure time from the image pickup device;
an image simultaneous readout unit that simultaneously performs readout of a plurality of images from the image pickup device;
a flicker area detecting unit that detects a flicker area in the first image where flicker is occurring by using the flicker frequency that has been detected by the frequency detecting unit and the plurality of images that have been read out by the image simultaneous readout unit; and
a correcting unit that corrects the flicker in the flicker area.

2. The image pickup apparatus according to claim 1, wherein
the flicker area detecting unit detects the flicker area from a difference image of the plurality of images.

3. The image pickup apparatus according to claim 1, wherein
the image simultaneous readout unit performs the readout of the plurality of images at a period shorter than a flicker period, which is a reciprocal of the flicker frequency that has been detected by the frequency detecting unit.

4. The image pickup apparatus according to claim 1, wherein
the plurality of images include images that have been read out at different readout times.

5. The image pickup apparatus according to claim 1, wherein
the plurality of images include images that have been exposed with a same exposure time.

6. The image pickup apparatus according to claim 1, wherein
the correcting unit corrects the flicker in the flicker area by using the flicker area, the first image, and a second image that has been photographed with an exposure time that is an integer multiple of the flicker frequency.

7. The image pickup apparatus according to claim 6, wherein
the first image and the second image are photographed successively at high speed.

8. The image pickup apparatus according to claim 7, wherein
the correcting unit uses a second image that has been photographed either before or after an exposure timing of the first image, or uses second images that have been photographed both before and after the exposure timing of the first image.

9. The image pickup apparatus according to claim 6, wherein
the correcting unit includes a trained model that estimates an image, in which an area where flicker is occurring of an area of the first image is complemented with the second image, from the flicker area, the first image, and the second image.

10. The image pickup apparatus according to claim 1, wherein
the plurality of images are images that have been read out from different pixels among the plurality of pixels in a same photographing cycle.

11. The image pickup apparatus according to claim 10, wherein
the plurality of images are read out so that their readout cycles overlap in the same photographing cycle.

12. A control method for an image pickup apparatus that reads out an image by using an image pickup device having a plurality of pixels, the control method comprising:
a frequency detecting step of detecting a flicker frequency from the image that has been read out from the image pickup device;
an image readout step of reading out a first image that has been exposed with an arbitrary exposure time from the image pickup device;
an image simultaneous readout step of simultaneously performing readout of a plurality of images from the image pickup device;
a flicker area detecting step of detecting a flicker area in the first image where flicker is occurring by using the flicker frequency that has been detected in the frequency detecting step and the plurality of images that have been read out in the image simultaneous readout step; and
a correcting step of correcting the flicker in the flicker area.

13. A non-transitory computer-readable storage medium storing a program for causing a computer to execute a control method for an image pickup apparatus that reads out an image by using an image pickup device having a plurality of pixels, the control method comprising:
a frequency detecting step of detecting a flicker frequency from the image that has been read out from the image pickup device;
an image readout step of reading out a first image that has been exposed with an arbitrary exposure time from the image pickup device;
an image simultaneous readout step of simultaneously performing readout of a plurality of images from the image pickup device;
a flicker area detecting step of detecting a flicker area in the first image where flicker is occurring by using the flicker frequency that has been detected in the frequency detecting step and the plurality of images that have been read out in the image simultaneous readout step; and
a correcting step of correcting the flicker in the flicker area.
